(19) United States
(12) Patent Application Publication
(10) Pub. No.: US 2024/0262007 A1
(43) Pub. Date: Aug. 8, 2024

(54) BRICK CLEANING SYSTEM

(71) Applicant: 9280-5597 Quebec Inc., Verdun (CA)

(72) Inventors: Tommy BOUILLON, Mont-Saint-Hilaire (CA); David DUFOUR, Lasalle (CA); Hugo CARTIER, St-Simon-de-Bagot (CA)

(21) Appl. No.: 18/567,737

(22) PCT Filed: Jun. 10, 2021
(86) PCT No.: PCT/CA2022/050933

§ 371 Date: Dec. 6, 2023

Related U.S. Application Data
(60) Provisional application No. 63/209,662, filed on Jun. 11, 2021.

(51) Int. Cl. B28D 1/00; B28D 1/04; B28D 7/02

(52) U.S. Cl. CPC B28D 1/001; B28D 1/047; B28D 1/048; B28D 7/02

(57) ABSTRACT

A brick cleaning system has: a frame; a first saw comprising a first motor and a first saw blade driven by the first motor, the first saw being connected to the frame; a second saw comprising a second motor and a second saw blade driven by the first motor, the second saw being connected to the frame; and a brick cart connected to the frame. The brick cart is configured to hold a brick. The brick cart selectively translates relative to the frame for feeding the brick in a space between the first and second saw blades such that the first and second saw blades remove mortar from opposite sides of the brick. A method for cleaning used bricks is also disclosed.

### CROSS-REFERENCE

The present application claims priority to U.S. Provisional Patent Application No. 63/209,662, filed Jun. 11, 2021, the entirety of which is incorporated herein by reference.

### FIELD OF TECHNOLOGY

The present technology relates to a brick cleaning system to clean previously used bricks to allow recycling and/or reuse of the bricks.

### BACKGROUND

When taking down existing masonry structure, for replacement, repair or restauration for example, the used bricks first need to have the mortar that is stuck to them removed before they can be reused. This is typically done manually by using manual and powered hand tools. This is hard and time-consuming work and can damage some of the bricks being cleaned.

The alternative to cleaning the brick is disposing of the bricks. However, this can be costly and is not environmentally friendly.

There is therefore a desire for a brick cleaning system that can clean bricks more easily and quickly.

Some automated brick cleaning systems exists. However, some of these systems are very large and cannot be provided at a construction site or, if they can, they cannot easily be taken from one construction site to another due to their large size. Some of these systems are not precise, do not clean the bricks sufficiently and/or can damage many of the bricks being cleaned. Some of these systems also do not allow bricks of different sizes to be cleaned by the system.

There is therefore a desire for a brick cleaning system that addresses at least some of the above inconveniences.

### SUMMARY

It is an object of the present technology to ameliorate at least some of the inconveniences present in the prior art.

The present technology provides a brick cleaning system having a pair of saws and a brick cart. A used brick is secured to the brick cart and the brick cart is translated to feed the brick between saw blades of the saws. As the brick passes between the saw blades, the saw blades remove mortar from the sides of the brick, thereby cleaning the brick. In some embodiments, the space between the saw blades can be adjusted.

According to one aspect of the present technology, there is provided a brick cleaning system having: a frame; a first saw comprising a first motor and a first saw blade driven by the first motor, the first saw being connected to the frame: a second saw comprising a second motor and a second saw blade driven by the second motor, the second saw being connected to the frame; and a brick cart connected to the frame. The brick cart is configured to hold a brick. The brick cart selectively translates relative to the frame for feeding the brick in a space between the first and second saw blades such that the first and second saw blades remove mortar from opposite sides of the brick.

In some embodiments of the present technology, the first saw blade is selectively movable relative to the frame to change a distance between the first saw blade and the second saw blade.

In some embodiments of the present technology, the second saw blade is selectively movable relative to the frame to change the distance between the first saw blade and the second saw blade.

In some embodiments of the present technology, a leadscrew is rotationally connected to the frame. The leadscrew has a first portion having a first thread handedness and a second portion having a second thread handedness. The first thread handedness is opposite the second thread handedness. A first motor mount is connected to the first motor. The first motor mount engages the first portion of the leadscrew. A second motor mount is connected to the second motor. The second motor mount engages the second portion of the leadscrew. Turning the leadscrew in a first direction moves the first motor mount and the second motor mount toward each other thereby moving the first saw and the second saw toward each other and reducing the distance between the first saw blade and the second saw blade. Turning the leadscrew in a second direction opposite the first direction moves the first motor mount and the second motor mount away from each other thereby moving the first saw and the second saw away from each other and increasing the distance between the first saw blade and the second saw blade.

In some embodiments of the present technology, a laser assembly is movably connected to the frame and is movable together with the first saw blade. The laser assembly is configured to project a line aligned with the first saw blade for aligning the brick in the brick cart.

In some embodiments of the present technology, the first saw is a first circular saw; the first saw blade is a first circular saw blade; the second saw is a second circular saw; the second saw blade is a second circular saw blade; and the first and second circular saw blades rotate about a common rotation axis.

In some embodiments of the present technology, a blade guard partially covers the first and second circular saw blades, the blade guard pivots as the brick cart translates to allow the brick to be received in the space between the first and second circular saw blades.

In some embodiments of the present technology, the brick cart is vertically lower than the common rotation axis of the first and second circular saw blades to feed the brick below the common rotation axis.

In some embodiments of the present technology, the first and second saw blades are disposed between the first and second motors.

In some embodiments of the present technology, an actuator is connected to the frame. The actuator is operatively connected to the brick cart for selectively translating the cart relative to the frame.

In some embodiments of the present technology, the actuator is a rack and pinion assembly.

In some embodiments of the present technology, the brick cart includes a vise for holding the brick.

In some embodiments of the present technology, a grinder is connected to the frame.

In some embodiments of the present technology, a hopper is connected to the frame below the first saw, the second saw, and the brick cart for receiving mortar removed from the brick.

In some embodiments of the present technology, the frame has a sloped brick storage area for storing bricks.

In some embodiments of the present technology, a saw housing is connected to the frame. The saw housing houses the first saw and the second saw therein. The saw housing defines a cart aperture in a side thereof. The brick cart selectively translates in and out of the housing via the cart aperture.

In some embodiments of the present technology, a dust collection system fluidly communicates with an interior of the saw housing via a dust collection aperture defined in the housing.

According to another aspect of the present technology, there is provided a method for cleaning a used brick comprising: securing the brick to a brick cart; and feeding the brick between a pair of operating saw blades by translating the brick cart for removing mortar from opposite sides of the brick.

In some embodiments of the present technology, the method further comprises adjusting a distance between the saw blades.

In some embodiments of the present technology, feeding the brick between the pair of saw blades by translating the brick cart comprises translating the brick cart from a first position to a second position. The method further comprises: returning the brick cart to the first position; and removing the brick from the brick cart.

Embodiments of the present technology each have at least one of the above-mentioned object and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects and advantages of embodiments of the present technology will become apparent from the following description, the accompanying drawings and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 is a perspective view taken from a front, left side of a brick cleaning system;

FIG. 2 is a close-up front elevation view of a portion of the brick cleaning system of FIG. 1;

FIG. 3 is a perspective view taken from a front, left side of the brick cleaning system of FIG. 1 with a saw housing removed;

FIG. 4 is a perspective view taken from a rear, right side of the brick cleaning system of FIG. 1 with the saw housing removed;

FIG. 5 is a top plan view of the brick cleaning system of FIG. 1 with the saw housing removed;

FIG. 6 is a front elevation view of the brick cleaning system of FIG. 1 with the saw housing removed;

FIG. 7 is a right side elevation view of the brick cleaning system of FIG. 1 with the saw housing removed;

FIG. 8 is a bottom plan view of the brick cleaning system of FIG. 1 with the saw housing removed:

FIG. 9 is a cross-sectional view of the brick cleaning system of FIG. 1 with the saw housing removed taken along line 9-9 in FIG. 5;

FIG. 10 is a cross-sectional view of the brick cleaning system of FIG. 1 with the saw housing removed taken along line 10-10 in FIG. 5:

FIG. 11 is a front elevation view of a portion the brick cleaning system of FIG. 1 with the saw housing removed and showing saw blades of the system at a first distance from each other:

FIG. 12 is a front elevation view of a portion the brick cleaning system of FIG. 1 with the saw housing removed and showing the saw blades at a second distance from each other:

FIG. 13 is a close-up of section 13 of FIG. 10;

FIG. 14 is a perspective view taken from a front, right side of saws, a saw adjustment system, a grinder and a brick cart of the brick cleaning system of FIG. 1:

FIG. 15 is a close-up perspective view taken from a front, left side of a brick cart of the brick cleaning system of FIG. 1:

FIG. 16 is a close-up perspective view taken from a front, left side of the brick cart of FIG. 15 with a portion of the brick cart removed to show a translation mechanism of the brick cart:

FIG. 17A is a schematic side elevation view of a used brick with mortar stuck to its sides:

FIG. 17B is a schematic side elevation view of the used brick of FIG. 17A after removing the mortar using the brick cleaning system of FIG. 17B:

FIG. 18 is a front elevation view of an alternative embodiment of the brick cleaning system of FIG. 1:

FIG. 19 is a cross-sectional view of the brick cleaning system of FIG. 18 with taken along line 19-19 in FIG. 18.

### DETAILED DESCRIPTION

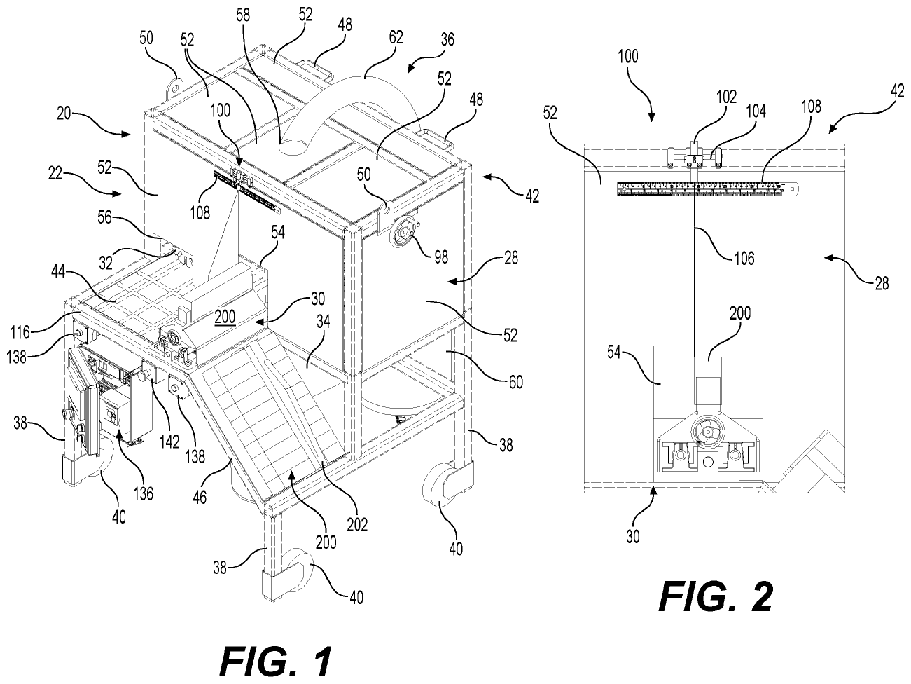

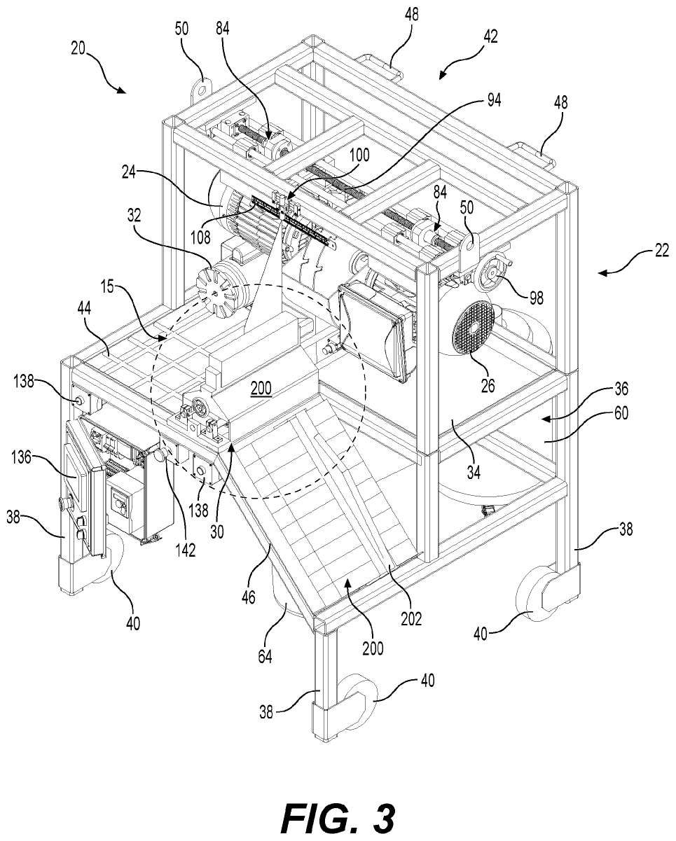

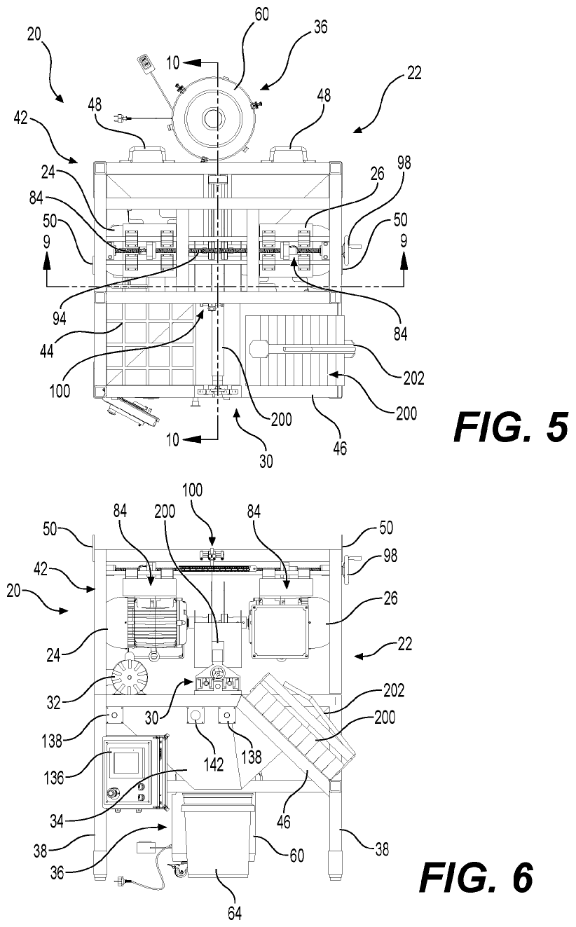

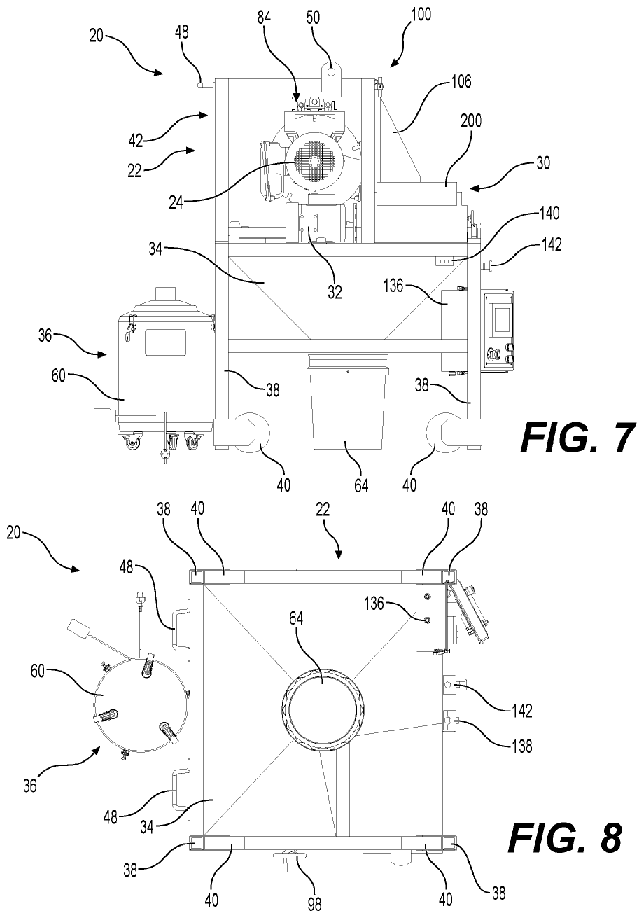

With reference to FIGS. 1 to 8, a brick cleaning system 20 will be described. The brick cleaning system has a frame 22. The brick cleaning system 20 also has a pair of saws 24, 26, a saw housing 28, a brick cart 30, a grinder 32, and a hopper 34 connected to the frame 20 as will be described in more detail below. The brick cleaning system 20 also has a dust collection system 36 communicating with an interior of the saw housing 28 as will be described in more detail below. The brick cleaning system 20 also has other components, some of which will be described below.

The frame 22 has four legs 38. Wheels 40 are connected to the lower ends of the legs 38 to facilitate displacement of the brick cleaning system 20. The upper rear portion of the frame 22 defines a saw frame portion 42. A horizontal grille 44 is provided on a front, right side portion of the frame 22 to provide a work area. The front left portion of the frame 22 is inclined to define a sloped brick storage area 46. The brick storage area 46 is used to place bricks 200 cleaned using the brick cleaning system 20. Once several bricks 200 have been placed on the brick storage area 46, these bricks 200 can be taken from the brick storage area 46 using brick tongs 202. It is contemplated that the bricks 200 could also be removed by hand or by other means from the brick storage area 46. The frame 22 is made of high strength steel, but other materials are contemplated.

A pair of handles 48 is provide at the upper rear portion of the frame 22. The handles 48 are used to facilitate displacement of the brick cleaning system 20 on its wheels 40. Lifting lugs 50 are provided on the left and right, front sides of the saw frame portion 42. The brick cleaning system 20 can be attached by the lifting lugs 50, to a lift for example, to move the brick cleaning system 20 in and out of a truck, a trailer, another type of vehicle, or a container to permit easy removal and deployment of the brick cleaning system on a construction site and to permit easy transport of the brick cleaning system 20 from one construction site to the other.

As can be seen in FIG. 1, the saw housing 28 is formed from sheet metal panels 52 fastened, welded, or otherwise connected to the top, left, right, front and rear sides of the saw frame portion 42. The sheet metal panels 52 are made from 16-gauge steel, but other materials are contemplated. The saw housing 28 houses the saws 24, 26 and the grinder 32 therein. The front panel 52 defines a cart aperture 54 at the bottom center thereof to permit the brick cart 30 to translate in and out of the saw housing 28 as will be described in more detail below. The front panel 52 also defines a grinder aperture 56 at the lower right corner thereof to permit access to the grinder 32 as will be described in more detail below. A flap (not shown) made of flexible material, such as vinyl for example, covers the grinder aperture 56 when the grinder 32 is not in use. It is contemplated that the flap could be omitted. The saw housing 28 provides some protection to the operator of the brick cleaning system 20 from pieces of mortar which could be projected while the brick 200 is being cleaned by the brick cleaning system 20.

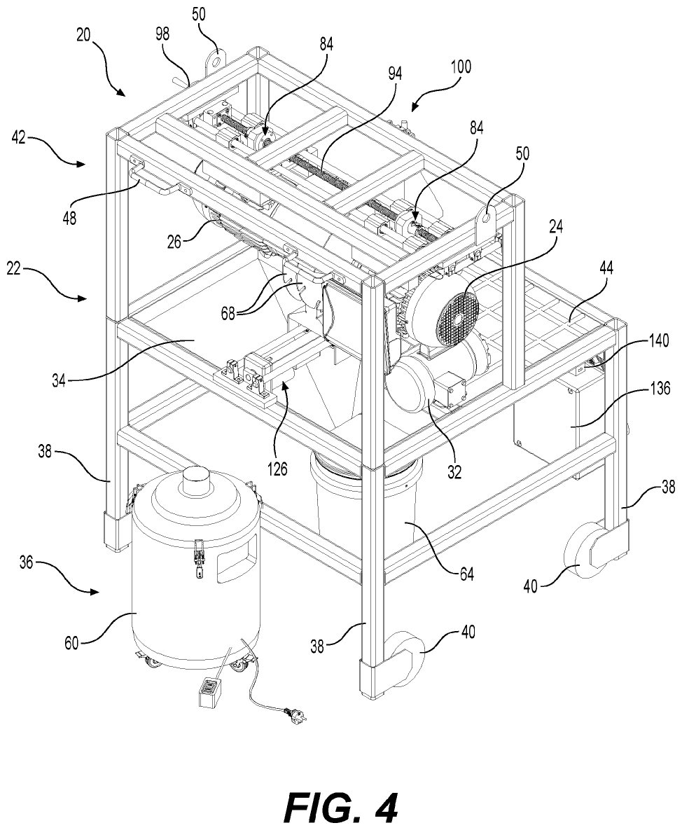

As can be seen in FIG. 1, the top center panel 52 of the saw housing 28 defines a dust collection aperture 58 to permit fluid communication between the interior of the saw housing 28 and the dust collection system 36. The dust collection system 36 includes a shop vacuum 60 and a vacuum hose 62 (FIG. 1). As best seen in FIG. 4, the vacuum 60 is disposed behind the frame 22. The hose 62 is connected between the vacuum 60 and the dust collection aperture 58. During operation of the brick cleaning system 20, the vacuum 60 is turned on such that the dust collection system 36 sucks at least a portion of the dust produced by the brick cleaning process from inside of the saw housing 28. The dust collection system 36 is disconnected from the rest of the brick cleaning system 20 when the brick cleaning system 20 is to be moved.

The hopper 34 is connected to the frame 22 below the saws 24, 26, the brick cart 30, the grinder 32 and the grille 44. As such, the pieces of mortar being removed from the brick 200 by the saws 24, 26 and the grinder 32 when the brick cleaning system 20 is used fall in the hopper 34. A bucket 64 (FIG. 6) placed under the lower end of the hopper 34 collects the mortar that has been received in the hopper 34. When the bucket 64 is full or nearly full, it can be emptied and put back in position or it can be replaced by another bucket 64.

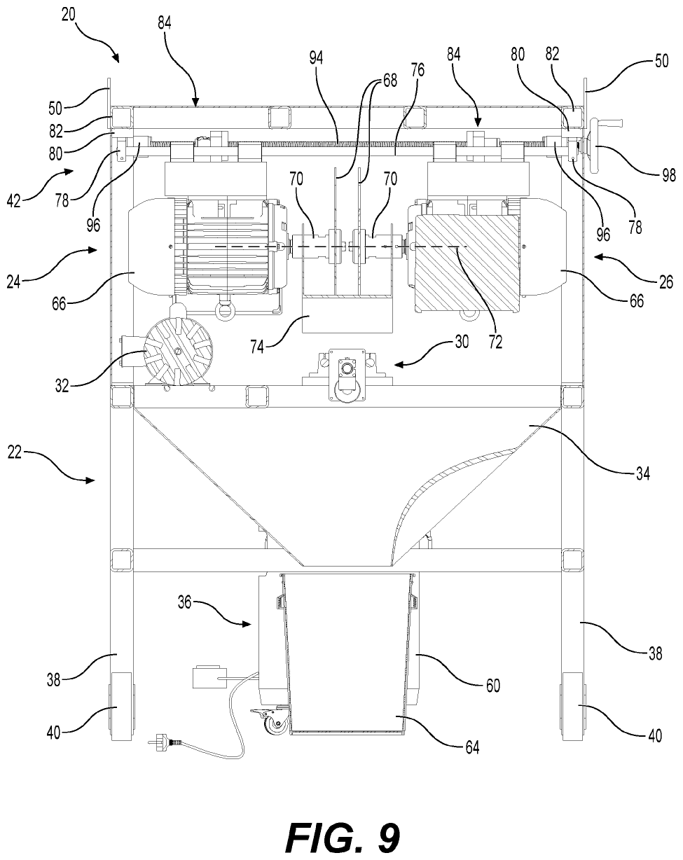

With reference to FIGS. 9 to 12 and 14, the saws 24 and 26 and their mounting systems will be described in more detail. As the saws 24, 26 and their respective mounting systems are mirror images of each other, only the right saw 24 and its mounting system will be described in detail. The components of the left saw 26 and its mounting system have been labeled with the same reference numerals in the figures.

The saw 24 includes a motor 66 that drives a saw blade 68. In the present embodiment, the saw 24 is a circular saw 68 and as such, the saw blade 68 is a circular saw blade 68. More specifically, in the present embodiment, the saw blade 68 is a circular diamond-tipped masonry saw blade 68 having a 14-inch diameter, but other types of saw blades are contemplated. In the present embodiment, the motor is an electric motor 66 that rotates the saw blade 68 via a shaft 70. More specifically, the motor 66 is a 3 horsepower, 3600 RPM, 220 volts, totally enclosed, fan-cooled (TEFC) electric motor, but other types of motors are contemplated. As can be seen in FIG. 9, in the present embodiment, the saw blades 68 of both saws 24, 26 rotate about a common rotation axis 72 and the saw blades 68 of the saws 24, 26 are disposed between the motors 66 of the saws 24, 26. It is contemplated that other types of saws, such as band saws for example, could be used in some embodiments. It is also contemplated that the saws 24, 26 could be wet saws to reduce dust generation.

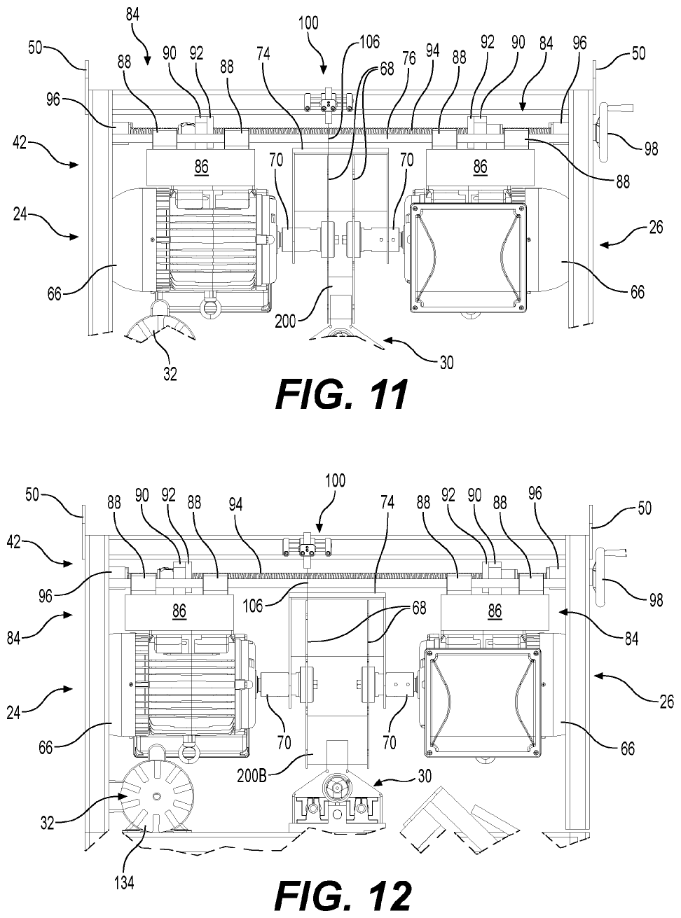

A blade guard 74 normally covers the lower front quarters of both saw blades 68. It is contemplated that the blade guard 74 could cover a greater or smaller portion of the saw blades 68. When the brick cart 30 translates to feed the brick 200 in the space between the saw blades 68, the blade guard 74 automatically pivots upward, as can be seen in FIG. 11, to permit the passage of the brick 200. It is contemplated that each saw blade 68 could have its own blade guard. It is also contemplated that in some embodiments, the blade guard 74 could be omitted.

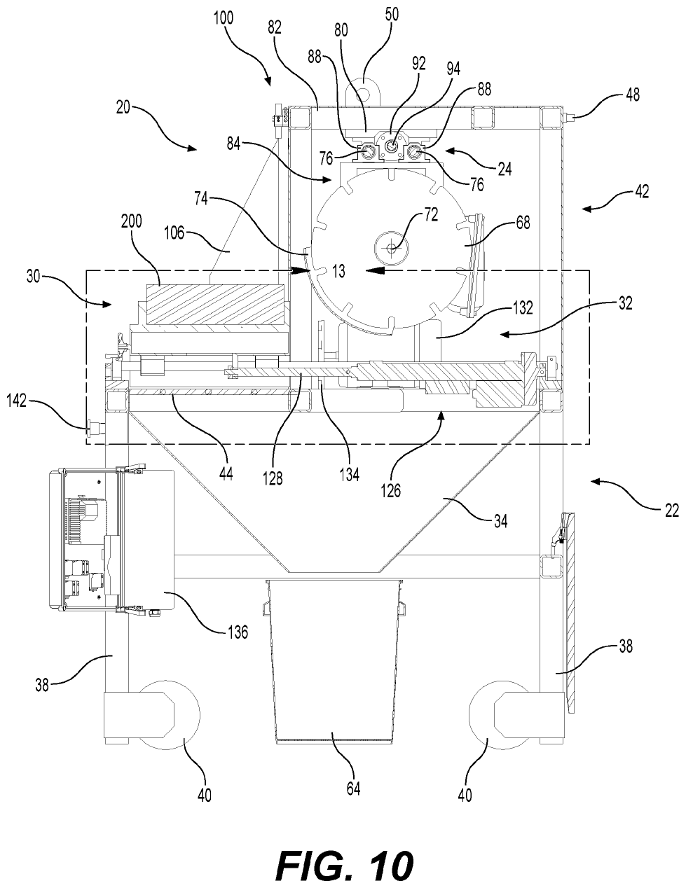

The saws 24, 26 are supported in the saw frame portion 42 by two shafts 76 extending laterally parallel to each other in upper portion of the saw frame portion 42. The ends of the shafts 76 are received in and connected to shaft supports 78. The shaft supports 78 are fastened to plates 80 (FIGS. 9 and 10) which are connected under upper side members 82 of the saw frame portion 42. Each saw 24, 26 is slindingly connected to the shafts 76 by a motor mount 84. As best seen in FIG. 14, each motor mount 84 includes a mounting bracket 86 connected to its corresponding motor 66 and four linear bearings 88 fastened to the top of the mounting bracket 86. Each shaft 76 is received in two of the linear bearings 88. Each motor mount 84 also includes a block 90 connected to the top of the mounting bracket 86. For each block 90, a flanged sleeve 92 is connected to and passes through the block 90. The sleeves 92 have internal threads. The internal threads of the two sleeves 92 have opposite thread handedness.

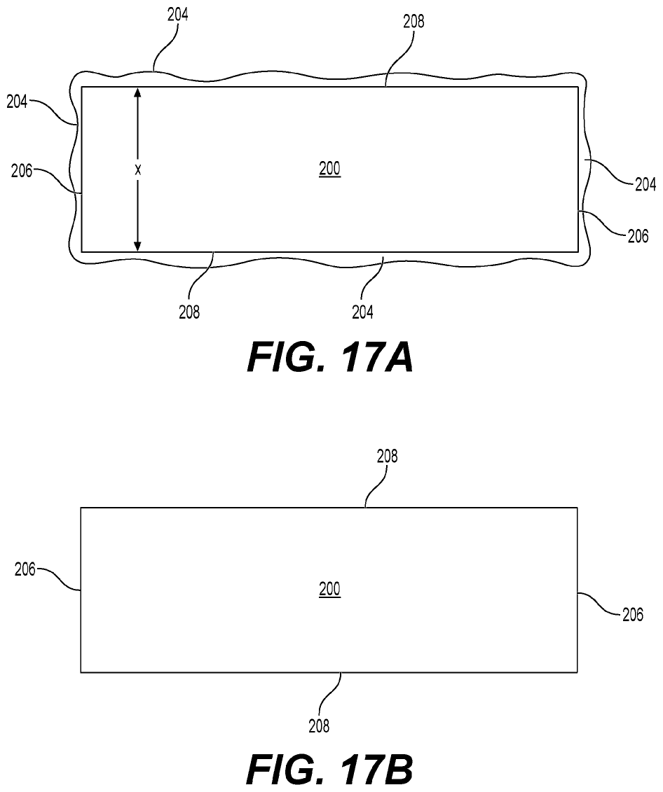

A leadscrew 94 extending laterally in the upper portion of the saw frame portion 42. The leadscrew 94 is disposed between the shafts 76, is vertically higher than the shafts 76, and extends parallel to the shafts 76. The end portions of the leadscrew 94 are each rotationally supported by a corresponding bearing 96. The bearings 96 are fastened to the plates 80. A handwheel 98 is connected to the left end of the leadscrew 94. The handwheel 98 is disposed outside of the saw housing 28. Turning the handwheel 98 turns the leadscrew 94. It is contemplated that the leadscrew 94 could be turned by a motor. The leadscrew 94 passes through the flanged sleeves 92 of both motor mounts 84. The right portion of the leadscrew 94 has a thread handedness corresponding to the thread handedness of the flanged sleeve 92 of the right motor mount 84 and the left portion of the leadscrew 94 has a thread handedness corresponding to the thread handedness of the flanged sleeve 92 of the left motor mount 84. As such, the left and right portions of the leadscrew 94 have opposite thread handedness. By turning the handwheel 98, and therefore the leadscrew 94, in one direction, the engagement between the leadscrew 94 and the motor mounts 84 causes the motor mounts 84 to move relative to the frame 22 toward each other, thereby moving the saws 24, 26 toward each other and reducing the distance between the saw blades 68. By turning the handwheel 98, and therefore the leadscrew 94, in the opposite direction, the engagement between the leadscrew 94 and the motor mounts 84 causes the motor mounts 84 to move relative to the frame 22 away each other, thereby moving the saws 24, 26 away from each other and increasing the distance between the saw blades 68. Therefore, the distance between the saw blades 68 can be changed to accommodate different sizes of bricks 200. As can be seen by comparing FIGS. 11 and 12, the distance between the saw blades 68 is greater in FIG. 12 than in FIG. 11 in order to clean the brick 200B of FIG. 12 that is larger than the brick 200 of FIG. 11. The distance between the saw blades 68 can also be adjusted in order to clean mortar from different opposed sides of the bricks 200. As can be seen in FIGS. 17A and 17B, the distance between the top and bottom sides of the brick 200 is smaller than the distance between the left and right sides of the brick 200.

It is contemplated that in some embodiments, one of the saws 24, 26 could have a fixed position and only the other one of the saws 24, 26 could be moveable. It is also contemplated that in embodiments where the brick cleaning system 20 is intended for cleaning a single size of bricks 200, both saws 24, 26 could be fixed. It is contemplated that the distance between the saw blades 68 could be adjusted by other mechanisms. It is contemplated that the saws 24, 26 could only be positioned at discrete positions such that the saw blades 68 could only be set at predetermined distances from each other corresponding to common brick sizes.

In order to allow the operator of the brick cleaning system 20 to properly set the distance between the saw blades 68, the brick cleaning system 20 is provided with a laser assembly 100. As best seen in FIGS. 2 and 14, the laser assembly 100 includes a laser 102 connected to a bracket 104. The bracket 104 connected to the front of the saw frame portion 42 and can slide laterally along the front of the saw frame portion 102. The laser 102 projects a line 106 that is laterally aligned with the saw blade 68 of the right saw 24. The bracket 104 is operatively connected to the motor mount 84 of the right saw 24 such that the laser 102 moves together with the saw blade 68 of the right saw 24 as can be seen by comparing FIGS. 11 and 12. A ruler 108 is connected to the front of the saw frame portion 42 below the laser assembly 100. To set the distance between the saw blades 68, the operator of the brick cleaning system 20 turns the handwheel 98 until the line 106 projected by the laser 102 is aligned with the desired dimension on the ruler 108. As will be described below, the line 106 projected by the laser 102 is also used to properly align the brick 200 to be cleaned in the brick cart 30. Alternatively, it is contemplated that the laser 102 could be aligned and movable with the saw blade 68 of the left saw 26. It is also contemplated that two laser assemblies 100 could be provided (one per saw blade 68). It is also contemplated that other means of indicating the distance between the saw blade 68 to the operator of the brick cleaning system 20 could be used.

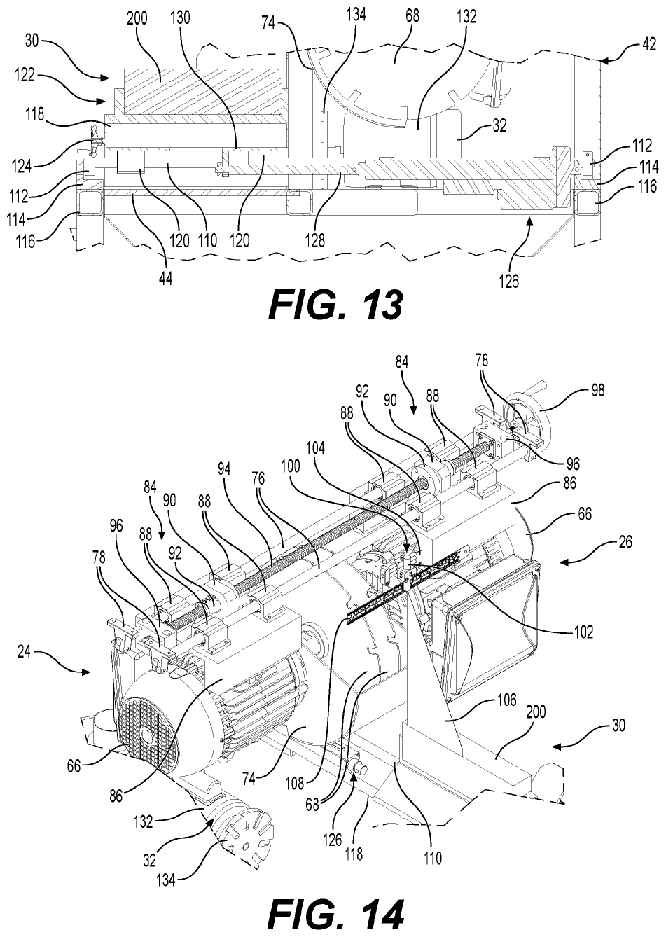

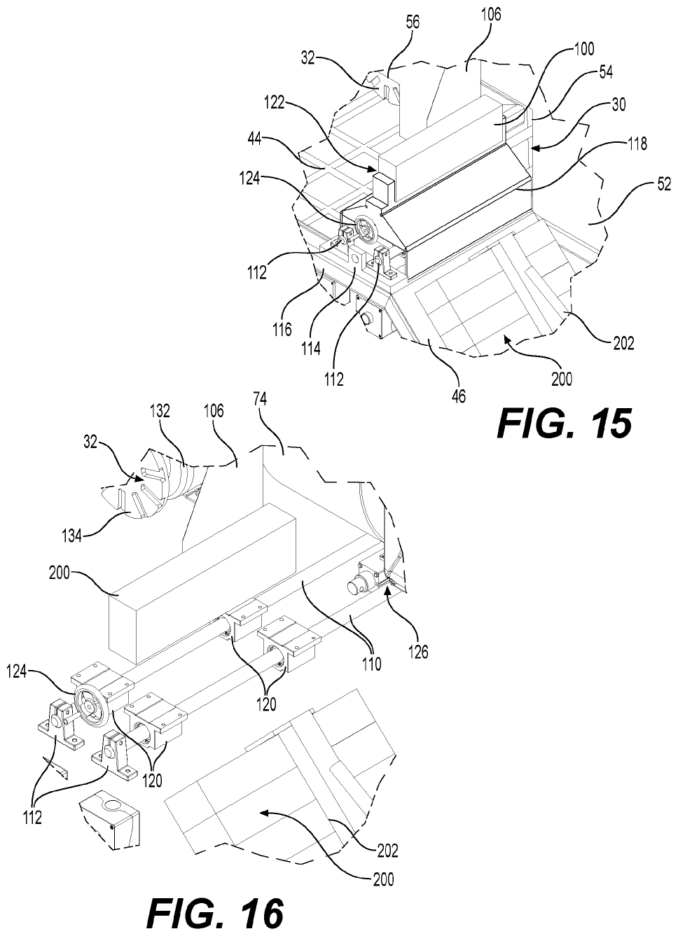

With reference to FIGS. 15 and 16, the brick cart 30 will be described in more detail. The brick cart 30 is vertically lower than the common rotation axis 72 of the saw blades 68 (see FIG. 9) in order to feed the brick 200 being cleaned below the common rotation axis 72. The brick cart 30 is supported on the frame 22 by two shafts 110 extending longitudinally parallel to each other and vertically lower than the saws 24, 26. The ends of the shafts 110 are received in and connected to shaft supports 112. The shaft supports 112 are fastened to brackets 114 (FIG. 13) which are connected over front and rear members 116 of the frame 22. The brick cart 30 includes a base 118 connected to four linear bearings 120. Each shaft 110 is passes through two bearings 120 thus supporting the brick cart 30 and allowing the brick cart 30 to translate longitudinally relative to the frame 22. The brick cart 30 includes a vise 122 is connected to the top of the base 118 for holding the brick 200 to be cleaned by the brick cleaning system 20. The vise 122 is operated by a handwheel 124 provided on the front of the base 118. It is contemplated that the brick 200 could be held on the brick cart 30 by other means.

To translate the brick cart 30 relative to the frame 22 in order to feed a brick 200 in the space between the saw blades 68 such that the saw blades 68 remove mortar from opposite sides of the brick 200, an actuator 126 is connected between the frame 22 and the brick cart 30. In the present embodiment, the actuator 126 is a linear electric cylinder having a retractable shaft 128. It is contemplated that other types of actuators 126 could be used. For example, the brick cart 30 could be translated by a rack and pinion assembly. As can be seen in FIG. 13, the rear of the actuator 126 is connected to the rear bracket 114 and the front end of the shaft 128 is connected to a bracket 130 that is connected to the bottom of the base 118 of the brick cart 30. When the shaft 128 of the actuator 126 is retracted, the brick cart 30 is translated toward the back of the frame 22. When the shaft 128 of the actuator 126 is extended, the brick cart 30 is translated toward the front of the frame 22, as shown in the figures.

Although not shown, the shafts 76, 110, the leadscrew 94 and the retractable shaft 128 are covered by flexible boots to help prevent dust from entering the bearings 88, 96, 120, the sleeves 92 and the actuator 126.

With reference to FIGS. 12 and 13, the grinder 32 includes an electric motor 132 that drives a grinding wheel 134. The grinding wheel 134 is a diamond grinding wheel, but other types of grinding wheels are contemplated. The grinder 32 is disposed in the saw housing 28 in alignment with the aperture 56. The front of the grinding wheel 134 is dispose rearward of the front panel 52 of the saw housing 28.

The electric motors 66 of the saws 24, 26, the electric motor 132 of the grinder 32, and the motor of the actuator 126 are electrically connected to an electric control box 136 provided at the front of the frame 22. The electric control box 136 is to be connected to a power outlet. A pair of push buttons 138 are provided at the front of the frame 22 below the front frame member 116. The push buttons 138 are electrically connected to the electric control box 136 and control the operation of the saws 24, 26 and of the actuator 126. Both push buttons 138 need to be pushed for the saws 24, 26 and the actuator 126 to operate. The push buttons 138 are spaced apart such that the operator needs to use both hands to push both push buttons 138, thereby ensuring that the hands of the operator are clear of the brick cart 30 and the saw blades 68. When the push buttons 138 are pushed, the electric control box 136 powers the motors 66 to turn the saw blades 68 and powers the actuator 126 to first translate the brick cart 30 into the saw housing 28 via the aperture 54 to feed the brick 200 between the saw blades 68 and then to translate the brick cart 30 back to its initial position shown in the figures. It is contemplated that contact switches could be used to determine when the brick cart 30 has reached its back position and its initial position. It is contemplated that the vacuum 60 could be electrically connected to the electric control box 136 so as to operate only when the push buttons 138 are pressed. A kill switch 142 is provided at the front of the frame 22 below the front frame member 116 between the push buttons 138. The kill switch 142 is electrically connected to the electric control box 136. The electric motor 132 of the grinder 32 is turned on and off by a switch 140 (FIG. 4) provided on the right side of the frame 22 and electrically connected to the electric control box 136. Pressing the kill switch 142 interrupts current to all the electric components of the brick cleaning system 20 that are connected to the electric control box 136.

A method for cleaning a used brick 200 using the brick cleaning system 20 will now be described. As can be seen in FIG. 17A, the used brick 200 (i.e., a brick 200 that was previously used in a masonry structure) has mortar 204 on its ends 206 and on its top and bottom sides 208. The operator of the brick cleaning system 20 measures the distance X between the top and bottom sides 208 of the brick 200 and sets the distance between the saw blades 68 using the handwheel 98, the laser assembly 100 and the ruler 108 as described above to correspond to the distance X. This step only needs to be performed once as long as the same size of bricks 200 are to be cleaned. The operator then activates the switch 140 to turn on the grinder 32 and removes the mortar 204 from both ends 206 of the brick 200 using the grinding wheel 134. Once the ends 206 are clean, the operator stops the grinder 32 using the switch 140. The operator then places the brick 200 in the vise 122 of the brick cart 30. The brick 200 is oriented in the vise 122 such that the cleaned ends 206 are at the front and back and that the sides 208 that still have mortar 204 on them are at the left and right. The operator then aligns the side of the brick 200 with the line 106 projected with the laser 102 to ensure that the sides 208 will pass between and adjacent to the laterally inner sides of the saw blades 68. Once the brick 200 is properly aligned with the line 106 projected by the laser 102, the operator secures the brick 200 to the brick cart 30 by tightening the vise 122 using the handwheel 124. The operator then pushes both push buttons 138. As a result, actuator 126 translates the brick cart 30 rearward to feed the brick 200 between the turning saw blades 68. As the brick cart 30 translates rearward, the blade guard 74 pivots to allow the brick 200 to be received in the space between the saw blades 68. As the brick 200 passes between the saw blades 68, the saw blades 68 remove the mortar 204 from the sides 208 of the brick 200. The brick cart 30 is then returned to its initial position by the actuator 126. When the brick cart 30 has returned to its initial position, the operator releases the push buttons 138, loosens the vise 122 using the handwheel 124 and removes the brick 200 from the brick cart 30. The brick 200 is now clean as shown in FIG. 17B. The cleaned brick 200 is placed on the brick storage area 46. The operator then picks up another brick 200 to be cleaned and repeats the above steps starting with the grinding of the mortar from the ends 206 of the brick 200. Once enough cleaned bricks 200 have been placed on the brick storage area 46, these bricks 200 are removed from the brick storage area 46 using brick tongs 202 and are placed on a pallet or wherever they are needed on the construction site.

It is contemplated that instead of grinding the mortar 204 from the ends 206 of the brick 200, this mortar 204 could also be removed using the saws 24, 26 by adjusting the distance between the saw blades 68 to correspond to the distance between the ends 206.

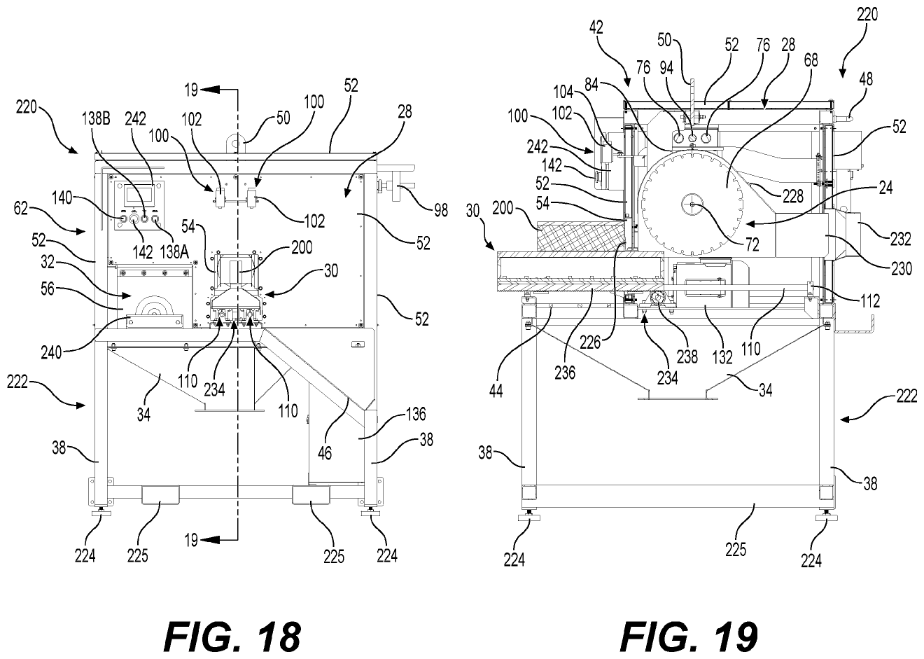

Turning now to FIGS. 18 and 19, a brick cleaning system 220 will be described. The brick cleaning system 220 is an alternative embodiment of the brick cleaning system 20. For simplicity, only the main differences between the brick cleaning system 220 and the brick cleaning system 20 will be described below. Features of the brick cleaning system 220 that are the same as or similar to those of the brick cleaning system 20 have been labeled with the same reference numbers and will not be described again.

The brick cleaning system 220 has a frame 222. Adjustable feet 224 are connected to the lower ends of the legs 38 of the frame 222. The frame 222 is not provided with wheels 40. Instead, two channels 225 are connected to the lower portion of the frame 222. The channels 225 are configured to receive the forks of a forklift. As such, the brick cleaning system 220 can be easily moved around a construction site with a forklift. A forklift can also be used to load the brick cleaning system 220 onto a truck and unload the brick cleaning system from the truck to move the brick cleaning system 220 from one construction site to another.

In the brick cleaning system 220, the vise 122 of the brick cart 30 has been replaced by a stopper 226 near the rear end of the brick cart 30. The operator of the brick cleaning system 220 places the brick 200 against the stopper 226 as shown in FIG. 19. As the brick cart 30 translates rearward thereby feeding the brick 200 between the turning saw blades 68, as a result of the direction of rotation of the saw blades 68, the force of the saw blades 68 engaging the mortar 204 pushes the brick 200 against the stopper 226. As such, no stopper is needed to abut the end of the brick 200 facing toward the front of the brick cleaning system 220. It is contemplated that a second stopper could nonetheless be provided to abut the end of the brick 200 facing toward the front of the brick cleaning system 220.

In the brick cleaning system 220, each saw 24, 26 is provided with laser assembly 100. As such, the operator of the brick cleaning system 220 can easily place the brick 200 on the brick cart 30 such that the sides 208 of the brick 200 are between the lines projected by the lasers 102 once the correct distance between the saw blades 68 has been set to correspond to the distance X between the sides 208 of the brick 200.

As can be seen in FIG. 19, a cowl 228 is provided in the saw housing 28 over a top portion of the saw blades 68. The cowl 228 helps direct dust resulting from the brick cleaning process toward a duct 230. The duct 230 fluidly communicates with a connector 232 that extends from the back of the frame 22 and that connects to a suction device such as the vacuum 60 described above. Alternatively, a duct (not shown) could connect the connector 232 to a dust collection container (not shown) to collect the dust without the use of a suction device. This replaces the dust collection system 36 of the brick cleaning system 20.

In the brick cleaning system 220, linear electric cylinder 126 has been replaced by a rack and pinion assembly 234. The rack and pinion assembly 234 includes a rack 236 connected to the bottom of the brick cart 30 between the shafts 110 and a pinion 238 engaging the rack 236 and being disposed below the rack 236. The pinion 238 is rotated by an electric motor (not shown) connected to the frame 222. As the pinion 238 rotates, the rack 236, and therefore the brick cart 30, translates rearward or forward depending on the direction of rotation of the pinion 238.

A shelf 240 is mounted onto the grille 44 in front of the grinder 32. The operator of the brick cleaning system 220 can place the brick 200 on the shelf 240 and then push it against the grinder 32.

A control panel 242 is mounted to the front of the saw frame portion 42 above the aperture 56 providing access to the grinder 32. The control panel 242 electrically communicates with the electric control box 136. The two push buttons 138 have been replaced by a button 138A and a button 138B on the control panel 242. Pressing the button 138A causes the rack and pinion system 234 to make the brick cart 30 reciprocate once (i.e. one rearward motion, followed by one forward motion). Pressing the button 138B turns the saws 24, 26 on and off. As such, the saws 24, 26 can be turned on and be left on for as long as the operator is cleaning bricks 200. The operator simply presses the button 138A each time a new brick 200 to be cleaned has been installed on the brick cart 30. The blades 68 continue while the cleaned brick 200 is removed and a new brick 200 to be cleaned is installed on the brick cart 30. A button 140 for turning the grinder on and off is also provided on the control panel 242. The kill switch 142 is also provided on the control panel 242.

Modifications and improvements to the above-described embodiments of the present technology may become apparent to those skilled in the art. The foregoing description is intended to be exemplary rather than limiting. The scope of the present technology is therefore intended to be limited solely by the scope of the appended claims.

1. A brick cleaning system comprising:
a frame;
a first saw comprising a first motor and a first saw blade driven by the first motor, the first saw being connected to the frame;
a second saw comprising a second motor and a second saw blade driven by the second motor, the second saw being connected to the frame; and
a brick cart connected to the frame, the brick cart being configured to hold a brick, the brick cart selectively translating from a first position to a second position relative to the frame for feeding the brick in a space between the first and second saw blades such that the first and second saw blades remove mortar from opposite sides of the brick, and the brick cart selectively translating from the second position to the first position for removing the brick from the space between the first and second saw blades.

2. The brick cleaning system of claim 1, wherein the first saw blade is selectively movable relative to the frame to change a distance between the first saw blade and the second saw blade.

3. The brick cleaning system of claim 2, wherein the second saw blade is selectively movable relative to the frame to change the distance between the first saw blade and the second saw blade.

4. The brick cleaning system of claim 3, further comprising:
a leadscrew rotationally connected to the frame, the leadscrew having a first portion having a first thread handedness and a second portion having a second thread handedness, the first thread handedness being opposite the second thread handedness;
a first motor mount connected to the first motor, the first motor mount engaging the first portion of the leadscrew; and
a second motor mount connected to the second motor, the second motor mount engaging the second portion of the leadscrew;
wherein:
turning the leadscrew in a first direction moves the first motor mount and the second motor mount toward each other thereby moving the first saw and the second saw toward each other and reducing the distance between the first saw blade and the second saw blade; and
turning the leadscrew in a second direction opposite the first direction moves the first motor mount and the second motor mount away from each other thereby moving the first saw and the second saw away from each other and increasing the distance between the first saw blade and the second saw blade.

5. The brick cleaning system of claim 2, further comprising a laser assembly movably connected to the frame and being movable together with the first saw blade, the laser assembly being configured to project a line aligned with the first saw blade for aligning the brick in the brick cart.

6. The brick cleaning system of claim 1, wherein:
the first saw is a first circular saw;
the first saw blade is a first circular saw blade;
the second saw is a second circular saw;
the second saw blade is a second circular saw blade; and
the first and second circular saw blades rotate about a common rotation axis.

7. The brick cleaning system of claim 6, further comprising a blade guard partially covering the first and second circular saw blades, the blade guard pivoting as the brick cart translates to allow the brick to be received in the space between the first and second circular saw blades.

8. The brick cleaning system of claim 6, wherein the brick cart is vertically lower than the common rotation axis of the first and second circular saw blades to feed the brick below the common rotation axis.

9. The brick cleaning system of claim 1, wherein the first and second saw blades are disposed between the first and second motors.

10. The brick cleaning system of claim 1, further comprising an actuator connected to the frame, the actuator being operatively connected to the brick cart for selectively translating the cart relative to the frame.

11. The brick cleaning system of claim 10, wherein the actuator is a rack and pinion assembly.

12. The brick cleaning system of claim 1, wherein the brick cart includes a vise for holding the brick.

13. The brick cleaning system of claim 1, further comprising a grinder connected to the frame.

14. The brick cleaning system of claim 1, further comprising a hopper connected to the frame below the first saw, the second saw, and the brick cart for receiving mortar removed from the brick.

15. The brick cleaning system of claim 1, wherein the frame comprises a sloped brick storage area for storing bricks.

16. The brick cleaning system of claim 1, further comprising a saw housing connected to the frame, the saw housing housing the first saw and the second saw therein, the saw housing defining a cart aperture in a side thereof, the brick cart selectively translating in and out of the housing via the cart aperture.

17. The brick cleaning system of claim 16, further comprising a dust collection system fluidly communicating with an interior of the saw housing via a dust collection aperture defined in the housing.

18. A method for cleaning a used brick comprising:
securing the brick to a brick cart;
feeding the brick between a pair of operating saw blades by translating the brick cart from a first position to a second position for removing mortar from opposite sides of the brick;
returning the brick cart to the first position with the brick thereon; and
removing the brick from the brick cart.

19. The method of claim 18, further comprising adjusting a distance between the saw blades.

20. (canceled)
